(19) United States
(12) Patent Application Publication
(10) Pub. No.: US 2026/0365505 A1
(43) Pub. Date: Nov. 19, 2026

(54) OPENING DEVICE

(71) Applicants: Andreas Ceconi, Salzburg (AT); Bernhard Simbürger, Salzburg (AT)

(72) Inventors: Andreas Ceconi, Salzburg (AT); Bernhard Simbürger, Salzburg (AT)

(21) Appl. No.: 19/121,071

(22) PCT Filed: Jun. 23, 2023
(86) PCT No.: PCT/EP2023/067142

§ 371 Date: Aug. 29, 2025

(30) Foreign Application Priority Data
Oct. 13, 2022 (AT) A 60158/2022

(51) Int. Cl. B67B 7/40; B65D 17/36

(52) U.S. Cl. CPC B67B 7/403; B65D 17/36

(57) ABSTRACT

A device for opening a beverage can, wherein the device has an actuating element with a fastening region, which can be positioned on a can-opening tab and has an actuating region operatively connected thereto, which can be grasped with the fingers and with which the can-opening tab can be actuated in order to open a drinking opening of the can.

### FIELD AND BACKGROUND OF THE INVENTION

The invention relates to an opening device for beverage cans.

Conventional beverage cans have a lid that is embodied as a stamped sheet metal part and is connected to the can body by means of a crimped edge. To open such cans, an opening is provided in the region of the can lid and is closed by an integrally joined sheet metal region, with the sheet metal region being connected to the rest of the can lid by means of a weakened zone or predetermined breaking point.

To actuate this region and produce an opening, a tab with an actuating ring is usually provided, which is connected to the can lid in an articulating fashion by means of a riveted connection. This tab has a larger, ring-like region that, when lifted from the can lid, presses a region at the diametrically opposite end relative to the connecting rivet toward the inside of the can when lifted. As a result, the region provided with the weakened zone or predetermined breaking point is pressed into the can, which causes the predetermined breaking point to tear open so that the can is opened.

KR 102056575B1 and KR 102146643B1 each disclose elements, which are positioned around an opening ring of a can and are bonded at their free ends. These can be connected to other protective covers in order to open the can when the protective cover is opened.

U.S. Pat. No. 3,434,622A discloses a can opening device in which the possible lever path is further enlarged by a resilient metallic lever. This metallic lever is riveted to the can lid and has multiple supports in the form of beads.

GB479601 discloses an opening device for tearing off a can lid of a can in which a lid run is completely torn off and thus the entire lid is removed; actuating elements such as bars with an eyelet or a hook with an eyelet, which are attached to the can and to an actuating tab, are provided for this purpose.

The object of the invention is to produce a device for opening a beverage can, which is simple and very inexpensive.

### SUMMARY OF THE INVENTION

The inventors have realized that although the conventional way of opening cans has proven to be reliable billions of times over, there are nevertheless disadvantages in that a high initial resistance must be overcome.

It has also turned out that particularly at events, people with artificial or naturally longer fingernails, especially painted ones, avoid opening cans and either do not buy them or ask for help to avoid damaging their fingernails. This adversely impacts acceptance of beverage cans, especially those with higher-quality contents. Irrespective of this, it is also difficult for certain finger sizes and finger properties to actuate the tab.

According to the invention, an opening device is provided, which consists of or has an actuating element that protrudes laterally in the extension of the can opening tab far enough that it can be grasped easily without the use of fingernails and as a result, the can opening tab can be pulled upward, i.e. away from the can.

According to the invention, this actuating element can consist of or comprise any type of high-tensile-strength material such as textiles, leathers, imitation leathers, polymers, metals, and the like and can be embodied in the form of a strap, a cord, a ring, a chain, or the like.

In one embodiment, this actuating element is embodied as a strap, which is looped for example onto a ring-like element of the can-opening tab. This strap can be open-ended or closed.

The actuating element can also be carried separately from a can and attached or hooked to the can-opening tab with an additional fastening element such as a metal or plastic hook, permitting the can to then be opened.

In addition, the opening device according to the invention can perform an indicator function so that for example the carbon dioxide content, a caffeine content, a sugar content, an alcohol content, or the like are indicated for example by means of a color code or the corresponding different use of colors, thus making it easier for the consumer to select.

The invention thus relates to a device for opening a beverage can, wherein the device has an actuating element with a fastening region, which can be positioned on a can-opening tab, and has an actuating region (8) operatively connected thereto, which can be grasped with the fingers and with which the can-opening tab (3) can be actuated in order to open a drinking opening of the can.

According to one modification, the fastening region is temporarily or permanently positioned on the can-opening tab.

According to one modification, the device is embodied as a strap that is looped into the opening of the can-opening tab, thus forming the fastening region in which the strap engages around a strut, which is formed by the can-opening tab and the opening.

According to one modification, at the end remote from the can-opening tab and the fastening region, the strap forms an actuating region in which at least one free end or a closed protruding loop is formed.

According to one modification, the strap is embodied as round or flat and is made of one or more of the group including: textile materials, polymer materials, natural, flexible materials, leathers, metallic sheets, and foils.

According to one modification, the opening device is embodied as an actuating element in the form of a pivotable tab or ring, with the pivotable tab or ring engaging around the strut, which results in an articulating arrangement of the opening device on the can-opening tab, which permits a pivoting motion.

According to one modification, the opening device is detachably positioned on the opening tab, with an actuating element and a fastening element operatively connected thereto, wherein the fastening element is in particular embodied to engage behind or detachably engage around the can-opening tab, in particular the strut.

According to one modification, the fastening element is embodied with a hook for hooking into the opening of the can-opening tab and engaging around the strut.

According to one modification, the strap is looped into an opening of the fastening element.

According to one modification, the strap is embodied as round or flat and is made of one or more of the group including: textile materials, polymer materials, natural, flexible materials, leathers, metallic sheets, and foils or is embodied as a rope, wire, or chain.

According to one modification, the actuating element is embodied as a plate, strut, tab, or the like, wherein the latter is embodied as integrally joined to the fastening element and positioned in a rigid or elastically pivotable fashion or the plate, strut, or tab is positioned on the fastening element in an articulating fashion.

According to one modification, the actuating element and/or the fastening element is embodied as metallic with a precious metal coating or is made of plastic with a metal coating or is correspondingly made of mixed materials.

According to one modification, the strap is embodied as long and closed into a loop so that the opening device can be worn around the neck.

According to one modification, the opening device has an indicator function and different detectable properties from the group including: color, haptics, optical pattern, and tactile contour are used to indicate the presence or contained quantity of ingredients or characteristics from the group including: carbon dioxide, caffeine and related substances, sugar, alcohol, sugar substitute, aromas, and flavors.

### BRIEF DESCRIPTION OF DRAWINGS

The invention is explained below by way of example with the aid of the drawings. In the drawings:

FIG. 1: is a very schematic depiction of a can lid with an opening device that is to be looped-in;

FIG. 2: shows a second step of the looping-in of the opening device;

FIG. 3: shows the opening device in the ready-to-use state;

FIG. 4: shows another advantageous embodiment of the opening device.

### DETAILED DESCRIPTION

The opening device 1 according to the invention has an actuating element 2 for actuating a can-opening tab 3.

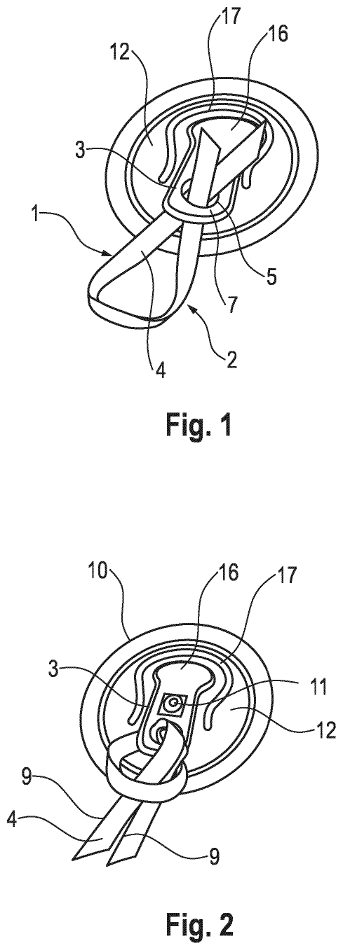

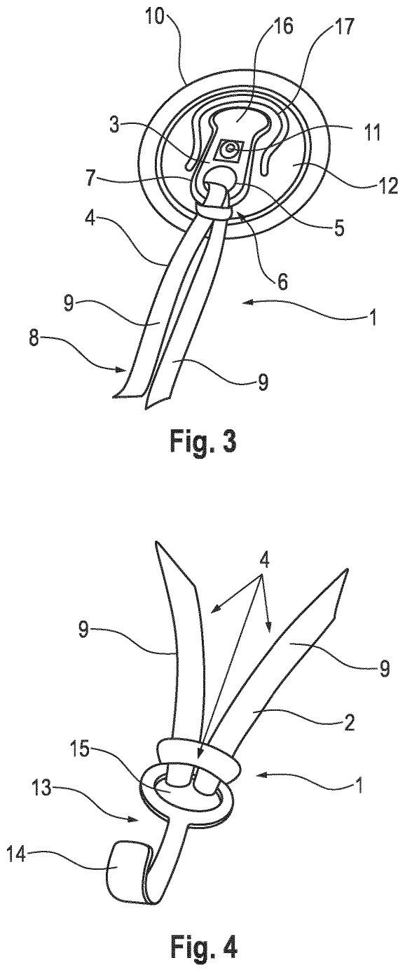

For example (FIGS. 1-3) , the actuating element 2 is embodied as a strap 4, which is looped into the opening 5 of the can-opening tab 3 in such a way that a fastening region 6 is formed in which the strap 4 engages around a strut 7, which is formed by the can-opening tab 3 and the opening 5. At the end remote from the can-opening tab 3, the strap 4 forms an actuating region 8, for example in that two free ends 9 are formed, which protrude away from the opening tab 3. In this case, the strap 4 also corresponds to the actuating element 2.

In this embodiment, the free ends 9 of the opening device 1 form two small tabs, which can be grasped, with the free ends 9 protruding from the can-opening tab 3 preferably over the rim 10 of a can, this position preferably being assumed when the cans are presented for sale.

In this case, the length of the free ends 9 or of the actuating element 2 can be dimensioned so that a rivet 11 for securing the can-opening tab 3 to a can lid 12 permits the free ends 9 to be pivoted inward to an opposite region of can rim 10 (not shown) for the purposes of transporting and stacking the cans.

It is naturally also possible for the free ends 9, particularly if they are longer than the can diameter, to be folded so that they fit inside the radius of the can rim 10 and thus disappear under the can on top of them when the cans are stacked.

The opening device 1 can naturally also be embodied with an actuating element 2 in the form of a closed loop (not shown) so that on the one hand, the actuating region 8 can be grasped, but alternatively, for example fingers can also be hooked into this closed loop of the actuating region 8 in order to open the can. This loop can also be pivoted onto the can lid 12 in the same way as described above for an open textile strap 4.

The opening device 1 can thus be embodied as an elongated strap 4 or as a closed loop, wherein the free ends 9 can be trimmed to a sharp point or be welded to prevent fraying.

The strap can be embodied as round or flat and can be made of textile materials, of polymer materials, or of natural, flexible materials such as leather, but can also be made of metal sheets, rings, rope, wire, chain, or foils or combinations thereof.

In addition, it is also possible to embody the opening device 1 as an actuating element 2 in the form of a pivotable tab (not shown) likewise made of a sheet metal or plastic, wherein the pivotable tab then engages around the strut 11, which is formed by the opening 5 and the can-opening tab 3. This produces an articulating arrangement of the opening device 1 on the can-opening tab 3, which permits a pivoting motion.

In this case, the opening device 1 can then be pivoted around this strut 11 and can be pivoted from a position resting on the opening tab 3 into a position protruding beyond the can rim 10.

In another advantageous embodiment (FIG. 4), the opening device 1 is positioned on the opening tab 3 not in a fixed way, for example by means of the above-mentioned loop connection, but instead the opening device 1 has an actuating element 2 and a fastening element 13 operationally connected thereto.

The fastening element 13 is particularly embodied to engage behind or detachably engage around the can-opening tab 3, in particular the strut 7.

For example, the fastening element 13 is embodied with a hook 14.

In this embodiment of the opening device 1 according to the invention, the hook 14 of the fastening element 13 is inserted into the opening 5 of the can-opening tab 3 and moved toward the strut 7 that is formed by the opening 5 and the can-opening tab 3 until the hook 14 engages around the strut 11.

In this embodiment, a corresponding textile or another above-described strap 4, rope, wire, or chain can be looped into an opening 15 of the fastening element 13 in the same way as is done through the opening 5.

The actuating element 2, however, can also be embodied as a plate, strut, tab, or the like. It can be integrally joined to the fastening element 13 and then positioned in a for example rigid or elastically pivotable fashion. It is also possible for the plate, strut, ring, or tab to be positioned on the fastening element 13 in an articulating fashion.

In this embodiment, since this embodiment is particularly not designed as a disposable article, the appearance can be of a correspondingly higher quality. For example, the actuating element 2 and fastening element 13 can be metallic and gold-plated or made of plastic with a metal coating or made of a corresponding mix of materials. If the actuating device is a loop or the like, then the textile or other material can be embodied in a particularly high-quality way by being made of a very high-quality fabric, a leather with a high-quality look, or the like.

In addition, the strap 4 can also be longer and closed, thus permitting the opening device 1 to be worn around the neck. Such an embodiment is also suitable for bar and counter staff who must open a large number of cans.

The opening device 1 functions in a comparable way in all cases.

The opening device functions as follows. After the opening device 1 protrudes beyond the can rim 10 with the free ends 9 of the textile strap 4 or the hook 14 engages around the strut 7, the free ends 9 or the strap 4 or a correspondingly protruding tab or the like can be grasped as an actuating element 2 and the can-opening tab 3 can be lifted in the region of the strut 7 without the fingernails coming into contact with the actual can or can-opening tab 3.

A lever region 16 of the can-opening tab 3 at the opposite end from the strut 11 then presses against the can lid 12, with the region that is pressed on here being surrounded in linear fashion in a known way by a predetermined breaking line 17 in such a way that the pressing of the lever region 16 against the can lid 12 causes the can lid 12 to tear open in an inward direction, thus uncovering a drinking opening in an intrinsically known way. When an opening device 1 with a hook 14 is used, this hook 14 can then be removed from the strut 7 and stowed away again.

An advantage of the invention is that beverage cans, in particular beverage cans at events and in particular beverage cans with high-quality contents such as sparkling wine beverages, spirits, and wine, can be adequately used in a way that is easy on the fingernails.

Opening devices according to the invention can naturally also be preinstalled in the manner described above. In addition, opening devices according to the invention can also be positioned elsewhere on a can or multipack for assembly by the user. In particular, the embodiment with a rear gripping device can also be arranged as a “give-away” item for repeated use on a can or multipack.

1. A device for opening a beverage can, comprising:
an actuating element having a fastening region for positioning the actuating element on a can-opening tab and an actuating region operatively connected to the can-opening tab for grasping the actuating element with one's fingers and for actuating the can-opening tab in order to open a drinking opening of the can,
wherein the opening device is a strap that is looped into an opening of the can-opening tab, thus forming the fastening region in which the strap engages around a strut, which is formed by the can-opening tab and the opening, or
the opening device is detachably positioned on the can-opening tab, with the actuating element and a fastening element operatively connected to the can-opening tab, wherein the fastening element engages behind or detachably engages around the strut, and the strap is looped into an opening of the fastening element or fastened to the fastening element in another way.

2. The device according to claim 1, wherein at an end remote from the can-opening tab and the fastening region, the strap forms the actuating region in which at least one free end or a closed protruding loop is formed.

3. The device according to claim 1, wherein the strap is round or flat and is made of one or more of the group consisting of: textile materials, polymer materials, natural, flexible materials, leathers, ropes, chains, and foils.

4. The device according to claim 1, wherein the fastening element comprises a hook for hooking into the opening of the can-opening tab and engaging around the strut.

5. The device according to claim 3, wherein the strap is round or flat and is made of one or more of the group consisting of: metal, metallic, and plastic ropes/chains.

6. The device according to claim 1, wherein the actuating element and/or the fastening element is metallic and gold-plated or is made of plastic with a metal coating or is made of a corresponding mix of materials.

7. The device according to claim 1, wherein the strap is sufficiently long and closed into a loop so that the opening device can be worn around one's neck.

8. The device according to claim 1, wherein the opening device has an indicator function and at least one detectable property selected from the group consisting of: color, haptics, optical pattern, and tactile contour, which is used to indicate a presence or contained quantity of at least one ingredient or characteristic selected from the group consisting of: carbon dioxide, caffeine and related substances, sugar, alcohol, sugar substitute, aromas, and flavors.

9. The device according to claim 1, wherein the opening device is detachably positioned on a can or multipack of cans for assembly by a user or for repeated use.
